(19) United States
(12) Patent Application Publication
(10) Pub. No.: US 2014/0149609 A1
(43) Pub. Date: May 29, 2014

(54) DETECTING DEVICE DISCONNECT IN A REPEATER

(71) Applicants: KOK HONG CHAN, Folsom, CA (US); HUIMIN CHEN, Portland, OR (US)

(72) Inventors: KOK HONG CHAN, Folsom, CA (US); HUIMIN CHEN, Portland, OR (US)

(21) Appl. No.: 13/688,887

(22) Filed: Nov. 29, 2012

(51) Int. Cl. G06F 13/38

(52) U.S. Cl. CPC G06F 13/385
USPC 710/16

(57) ABSTRACT

A method for detecting device disconnect in a repeater is disclosed herein. The method includes receiving a disconnect indication comprising a voltage swing occurring on a data channel for a peripheral device. The method also includes receiving a start-of-frame indication that indicates that a threshold consecutive number of bits of the same data value has been received. The method further includes sending a device disconnect message to a host based on the disconnect indication and the start-of-frame indication.

### BACKGROUND

Modern computing systems can include a variety of communication devices that send and receive data. Examples of communication devices include parallel interface devices and serial interface devices such as the universal serial bus (USB). USB is an industry protocol designed to standardize the interfaces between computer devices for communication and supplying electrical power. The USB protocol has enjoyed widespread adoption in nearly every computing device, and has received tremendous support in terms of technology development with well-established intellectual property (IP) portfolios and standardized software infrastructure.

The standard USB2 specification uses 3.3 Volt analog signaling for communications between the two USB2 ports. The 3.3 Volt signal strength tends to introduce integration challenges because some advanced semiconductor processes are moving towards a very low geometry leading to the gate oxide of a CMOS transistor no longer able to tolerate higher voltages, such as 3.3 Volt. In addition, the standard USB2 specification results in relatively high levels of power consumption at both idle and active states. As a result, USB2 may not be suitable for devices that place stringent specifications on I/O power consumption, such as mobile platforms.

### BRIEF DESCRIPTION OF THE FIGURES

The following detailed description may be better understood by referencing the accompanying drawings, which contain specific examples of numerous objects and features of the disclosed subject matter.

FIG. 1 is a block diagram of a system configured to communicate data between a system-on-chip (SOC) and a peripheral device.

FIG. 2 is an illustration of repeater architecture.

FIGS. 3A and 3B are diagrams of a differential transmitter connected to and disconnected from a device receiver, respectively.

FIG. 4 is an example of a start-of-frame (SOF) packet in accordance with embodiments.

FIG. 5 is an example of a standard packet in accordance with embodiments.

FIGS. 6A and 6B are block diagrams of circuits for detecting an SOF packet and for qualifying a disconnect envelope detector output.

FIG. 7 is an analog integrator circuit configured to determine whether or not a packet is a start-of-frame (SOF) packet.

FIG. 8 is a digital counter circuit configured to determine whether or not a packet is a start-of-frame (SOF) packet.

FIG. 9 is a process flow diagram of a method to detect device disconnect in a repeater in accordance with embodiments.

FIG. 10 is a process flow diagram summarizing method to detect device disconnect in a repeater.

### DETAILED DESCRIPTION

eUSB2 is a newly proposed input/output (IO) solution that aims to reduce the voltage cost and power consumption of USB 2.0 interfaces, eUSB2 uses 1.0 Volt (V) digital signaling instead of the 3.3 Volt analog signal in USB 2.0 Low-Speed (LS) and Full-Speed (FS) operations. Additionally, eUSB2 uses 0.2 V differential signaling instead of the 0.4 V differential signaling for USB 2 High-Speed (HS) interfaces. Due to the differences in the signal strength of USB2 and eUSB2, an eUSB2 repeater may be used as an electrical bridging solution to ensure that these two IO implementations may communicate with each other.

A clock-less half-duplex eUSB2 repeater can be used to bridge communications between a USB2 interface and a low-voltage signaling interface such as eUSB2. A clock-less half-duplex eUSB2 repeater, also referred to herein as an eUSB2 repeater, is a device that can communicate data between a standard USB2 interface and a low-voltage signaling interface without a clock source, such as a phase locked loop (PLL), as an input. A clock-less half duplex eUSB2 repeater cannot implement clock data recovery to decode and retime a data packet. The traffic flow control in a clock-less half duplex repeater can be implemented by detecting the raw electrical signaling level. A low voltage, as referred to herein, includes any voltage used to transmit data by an eUSB2 protocol. For example, an eUSB2 interface is a low-voltage signaling interface that may send and receive data at 0.2 V for high-speed data transmission, while a standard USB2 interface may send and receive data at a higher voltage of 0.4 V for high-speed data transmission. A high voltage, as referred to herein, includes any voltage used to transmit data by a standard USB2 protocol.

In accordance with embodiments, a repeater is configured to detect device disconnect between interfaces of different communication physical layers, such as USB2 and eUSB2. The repeater can employ a simple filtering mechanism to recognize an instruction to detect downstream device disconnect without the repeater having the capability to decode data packets.

Reference in the specification to “one embodiment” or “an embodiment” of the disclosed subject matter means that a particular feature, structure, or characteristic described in connection with the embodiment is included in at least one embodiment of the disclosed subject matter. Thus, the phrase “in one embodiment” may appear in various places throughout the specification, but the phrase may not necessarily refer to the same embodiment.

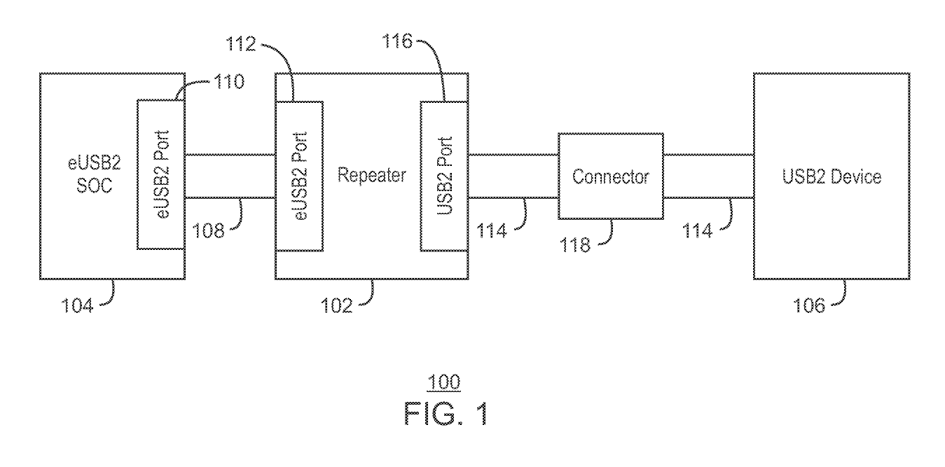

FIG. 1 is a block diagram of a system configured to communicate data between a system-on-chip (SOC) and a peripheral device. In embodiments, the system 100 includes a repeater 102 that allows for data to be communicated between an eUSB2 SOC 104 and a USB2 device 106. The eUSB2 SOC 104 can communicate with USB2 device 106 at low speed, full speed, or high speed. The eUSB2 SOC 104 can communicate data to the repeater 102 through eUSB2 data wires eD+/eD− 108 that connect an SOC eUSB2 port 110 to a repeater eUSB2 port 112. The USB2 device 106 may be connected to the repeater 102 by a pair of USB2 data wires D+/D− 114 that connect a repeater USB2 port 116 to a connector 118. The connector 118 allows for the USB2 device 106 to send and receive data from the repeater 102. The USB2 device 106 can communicate using any universal serial bus protocol. For example, the USB2 device may include functionality to communicate with other devices with a USB 1.0 or USB 2.0 protocol.

In embodiments, the repeater 102 can detect and forward data that is received from either the USB2 device 106 or eUSB2 SOC 104. For example, the repeater 102 may detect a sequence of electrical signals that represent data to transmit from the eUSB2 SOC 104 to the USB2 device 106 at a high speed. In embodiments, the repeater 102 can detect and execute commands.

If the USB2 device 106 becomes disconnected, the repeater 102 can signal to the eUSB2 SOC 104 that device disconnect has occurred. In embodiments, a special data packet can be transmitted from the eUSB2 SOC 104 to confirm that the disconnect event is legitimate.

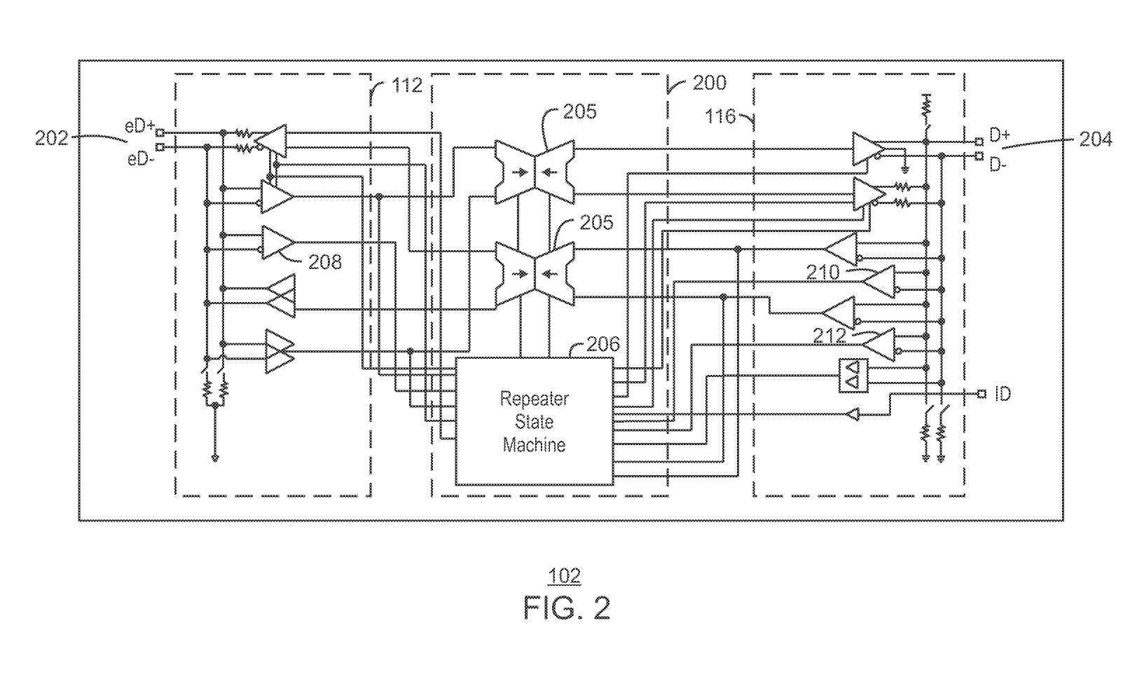

FIG. 2 is an illustration of repeater architecture. The repeater architecture 102 may include a repeater 200, a repeater eUSB2 port 112 and a repeater USB2 port 116. The repeater eUSB2 port 112 can send and receive data in a low voltage signal such as eD+ and eD− 202. The repeater USB2 port can send and receive data in a high voltage signal such as D+ and D− 204. The repeater 200 can convert the low voltage signal 202 into a high voltage signal 204 and a high-voltage signal 204 into a low voltage signal 202 using a level-shifting mux 205. The level-shifting mux 205 can function as a voltage converter and a multiplexer. The low voltage signals 202 and the high voltage signals 204 can provide the repeater architecture 102 with data to send through the repeater eUSB2 port 112 or the repeater USB2 port 116. The repeater architecture 102 may forward data received from the low voltage signals 202 to the high voltage signals 204 or from the high voltage signals 204 to the low voltage signals 202. Unidirectional traffic flow can be controlled by a repeater state machine 206 in the repeater 102. In some embodiments, the low voltage signals 202 and high voltage signals 204 can transmit commands for the repeater 102 to execute. For example, a command to reset the eUSB2 repeater state machine 206 can be executed without sending the command to the repeater USB2 port 116.

The repeater eUSB2 port 112 may include an eUSB2 unsquelch circuit 208 configured for detecting line activity. In embodiments, the eUSB2 unsquelch circuit 208 can be repurposed to also receive a start-of-frame indication. The eUSB2 unsquelch circuit 208 can receive data packets received from the low voltage signals 202. The eUSB2 unsquelch circuit 206 can measure the differential voltage of the packet, which can help determine whether or not a packet is a start-of-frame (SOF) packet. The repeater USB2 port 116 may also include a disconnect envelope detector circuit 212 configured to receive a disconnect indication. The disconnect envelope detector circuit 212 can check the voltage of signals transmitted between the repeater USB2 port 116 and a device USB2 port 106. If the voltage exceeds a certain threshold, the disconnect envelope detector circuit 212 can send an output to the repeater state machine 206 indicating that a possible disconnect event has been detected. The repeater can be configured such that the output can be sent to the repeater state machine 206 only if either the eUSB2 unsquelch circuit 208 detects an SOF packet.

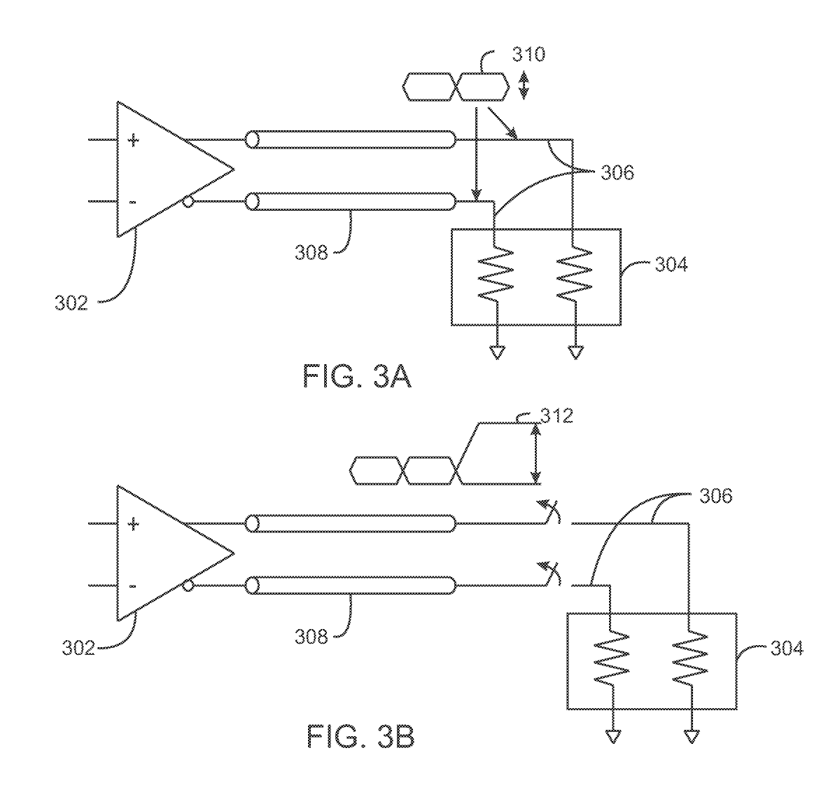

FIGS. 3A and 3B are diagrams of a differential transmitter connected to and disconnected from a device receiver, respectively. In FIG. 3A, a differential transmitter 302 is communicatively connected to a device receiver 304 through wires 306 in a channel 308. In some embodiments, the differential transmitter 302 is a USB2 transmitter found in a USB2 port of a repeater, and the device receiver 304 is a USB2 receiver found in a USB2 device. While connected, the differential transmitter 302 sends a signal pulse 310 that across the wires 306. The signal pulse 310 remains stable, and the voltage swing of the signal pulse 310 does not exceed a threshold. In some embodiments, the maximum voltage swing of the signal pulse 310 is 400 mV and the threshold can fall in a range between 525 mV and 625 mV. As long as the differential transmitter 302 and the device receiver 304 are in a state of connect, a disconnect envelope detector will not send any output indicating device disconnect.

In FIG. 3B, the differential transmitter 302 is disconnected from the device receiver 304. When disconnected, the voltage swing of the differential transmitter 302 through the wires 306 can increase, as shown by a disconnect signal 312, due to reflection from an open-ended wire. The voltage swing of the disconnect signal 312 can be substantially larger than the maximum voltage swing of the signal pulse 310, such that the threshold is exceeded. In some embodiments, the voltage swing of the disconnect signal 312 is approximately double of that of the signal pulse 310. The disconnect envelope detector can detect the disconnect signal 312, and send an output indicating device disconnect.

Reflections due to impedance discontinuities in the wire can also cause the voltage swing to momentarily exceed the threshold while the differential transmitter 302 and the device receiver 304 are still connected. In order to prevent a false declaration of device disconnect due to wire reflection, the repeater can require that a special data packet, which has sufficiently long static bits to allow the reflection to subside, be transmitted. A USB2 start-of-frame (SOF) packet can be used for this purpose. A mechanism can be defined for a clockless repeater to identify the SOF packet without having to decode a Packet Identifier (PID) through a clock data recovery circuit. The mechanism, which can involve the unsquelch circuit and other filtering circuits, is described hereafter.

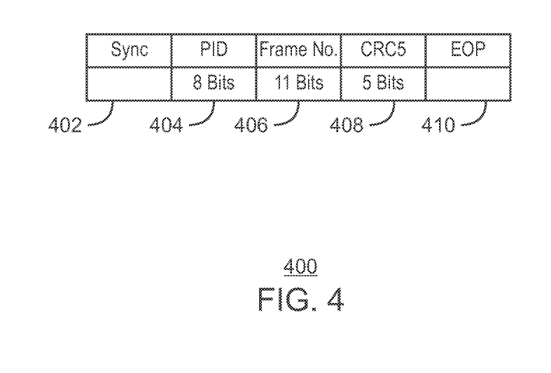

FIG. 4 is an example of a start-of-frame (SOF) packet in accordance with embodiments. The SOF packet 400 can be transmitted as part of the device disconnect detection scheme. The repeater can be configured to distinguish the SOF packet 400 from a standard packet.

The SOF packet 400 can be transmitted from an eUSB2 SOC and be detected by an unsquelch detector in the repeater. The SOF packet 400 can be used by the repeater to determine whether or not to accept and read an output from a disconnect envelope detector (from the USB2 port), thus reducing the chance of reading a false disconnect event. The SOF packet 400 can include a SYNC pattern 402, a Packet Identifier (PID) 404, a frame number 406, a cyclic redundancy check (CRC) 408, and an end-of-packet (EOP) 410. The EOP 410 is not only used as an indicator of the packet's end, but also to identify the packet as an SOF packet. The EOP segment 410 can be a set number of consecutive bits held at differential “1” or “0” that is substantially longer than the EOP segment of a standard packet. In some embodiments, the repeater is configured to identify a packet as an SOF packet if the number of consecutive static bits in the EOP segment 410 is equal to or larger than a defined SOF threshold. The SOF threshold can be a number that is larger than the number of consecutive static bits in the EOP segment 410 of a standard packet, but no larger than the number of consecutive static bits in the EOP segment 410 of the SOF packet 400. In some embodiments the EOP segment 410 of the SOF packet 500 includes 40 consecutive static bits.

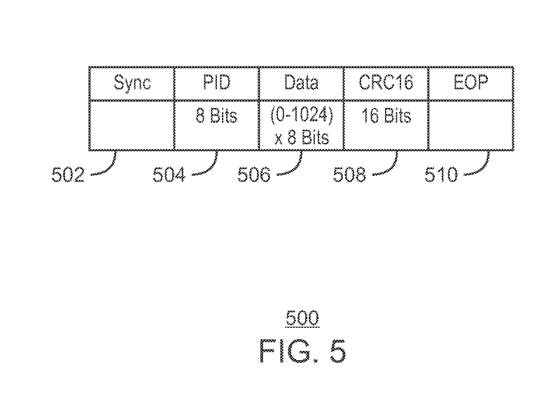

FIG. 5 is an example of a standard packet in accordance with embodiments. The standard packet 500 can be used as an envelope containing information or commands from a host to a peripheral device, or from a peripheral device to a host. The composition of the standard packet 500 can be different from the SOF packet 400 used for device disconnect detection.

The standard packet 500 can be transmitted from an SOC port to a peripheral device port, or from a peripheral device port to an SOC port. The standard packet 500 can also be forwarded from an eUSB2 SOC to a USB2 device, or from a USB2 device to an eUSB2 SOC, through a repeater. The standard packet 500 can include a SYNC pattern 502, a Packet Identifier (PID) 504, a data payload 506, a cyclic redundancy check (CRC) 508, and an end-of-packet (EOP) 510. The data payload 506 can include data or instructions from the SOC or device encoded as static bits of differential “1” or “0”. The number of consecutive static bits at either “1” or “0” cannot exceed a data payload threshold. In some embodiments, the data payload threshold is 7 bits due to data encoding implementation in USB2. The EOP 510 is an indicator of the packet's end. The EOP 510 can be a set number of consecutive bits held at “1” or “0” that exceed the data payload threshold. In some embodiments, the EOP segment 510 includes 8 consecutive static bits.

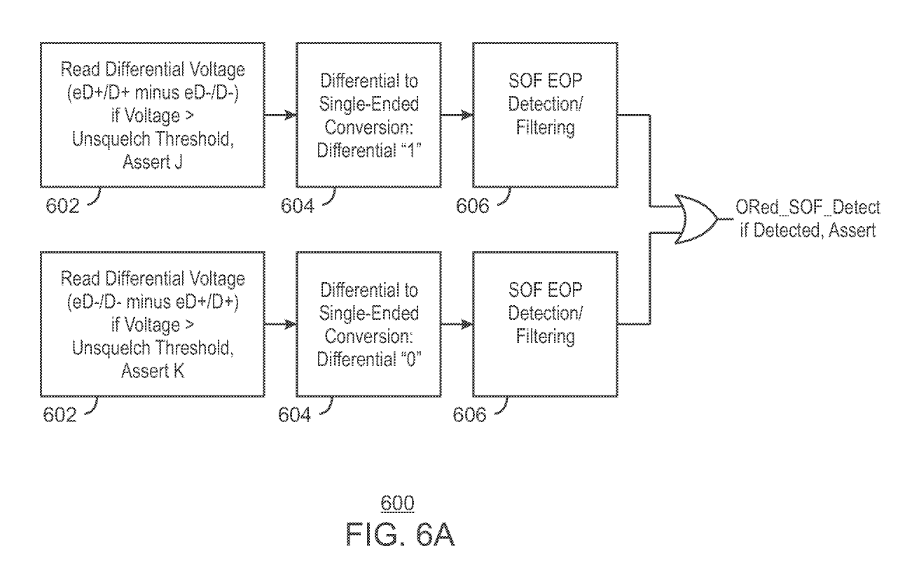

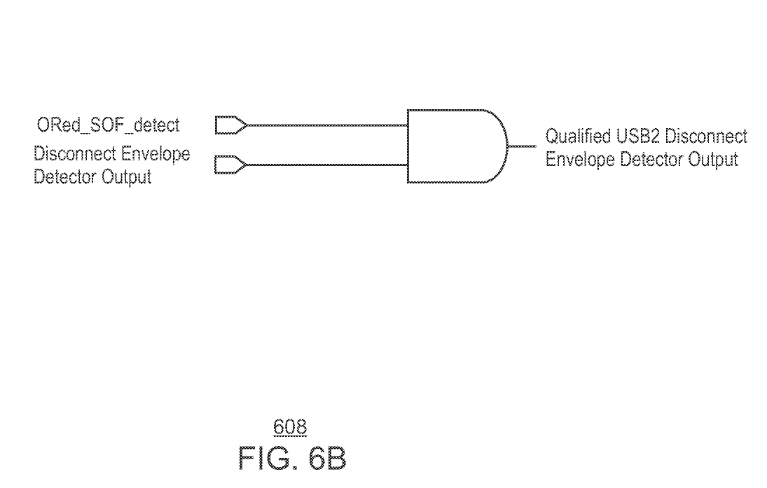

FIGS. 6A and 6B are block diagrams of a SOF detection circuit and a disconnect output qualifier circuit of a repeater. In embodiments, the SOF detection circuit 600 can be located in the repeater eUSB2 port 112 or the repeater USB2 port 116. The SOF detection circuit 600 can also include the eUSB2 unsquelch circuit 208.

At block 602, the SOF detection circuit 600 reads the differential voltage, of a data packet received by the repeater eUSB2 port 112. In embodiments, the differential voltage of the data packet may be detected by the eUSB2 unsquelch circuit 208. The SOF detection circuit 600 measures the voltage difference between the repeater's data wires, which can be eD+ and eD−, for each bit in the data packet. If the voltage difference between the positive and negative data wires exceeds an unsquelch threshold, then the SOF detection circuit 600 proceeds onto the next block.

At block 604, the SOF detection circuit 600 converts the data packet from differential signaling to single-ended signaling. Each bit in the data packet is converted into a static bit identified as differential “1” or differential “0”. If the voltage of the positive wire (eD+ or D+) is greater than the voltage of the negative wire (eD− or D−), the static bit may be identified as differential “1”. If the voltage of the negative wire (eD− or D−) is greater than the voltage of the positive wire (eD+ or D+), then the static bit may be identified as differential “0”.

At block 606, SOF detection circuit 600 examines the data packet to determine whether or not the data packet is an SOF packet. The SOF detection circuit 600 searches for an EOP segment belonging to an SOF packet. In embodiments, the EOP segment contains 40 consecutive static bits of the same data value. The SOF detection circuit 600 checks for whether or not a threshold for number of consecutive static bits is met. The threshold for number of consecutive static bits can be larger than the number of consecutive static bits found in the EOP segment of a standard packet, but no larger than the number of consecutive static bits found in the EOP segment of an SOF packet. If the data packet is indeed an SOF packet, the SOF detection circuit 600 notifies the disconnect output qualifier circuit 608 that an SOF packet has been detected. The implementation used to perform this step can be analog or digital.

FIG. 6B illustrates the disconnect output qualifier circuit 608. The disconnect output qualifier 608 can determine whether or not a possible device disconnect event detected by the disconnect envelope detector 212 is legitimate. The disconnect output qualifier 608 is configured to receive a disconnect envelope detector output as well as a notification from the SOF detection circuit 600 that an SOF packet has been detected. If both the output and the notification are received, the disconnect output qualifier 608 can qualify the disconnect envelope detector output as legitimate, and signal to the repeater state machine 206 that a device disconnect event has been detected.

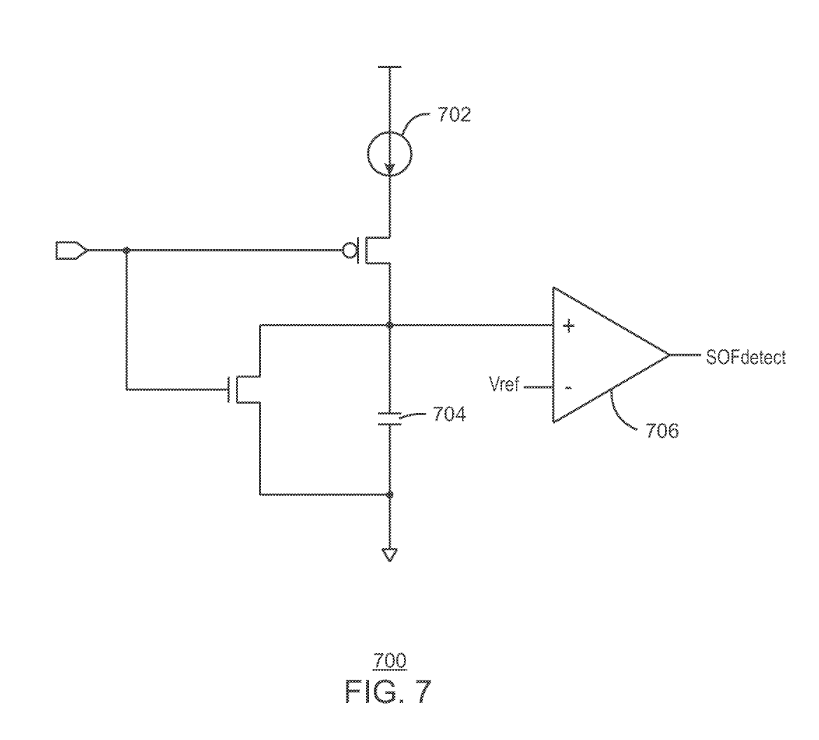

FIG. 7 is an analog integrator circuit configured to determine whether or not a packet is a start-of-frame (SOF) packet. The analog integrator circuit 700 can be used to determine whether or not a data packet includes the necessary number of consecutive static bits to be identified as an SOF packet. The analog integrator circuit 700 can include a current source 702, a capacitor 704, and a comparator 706. When a signal of “1” or “0” is asserted, the current source 702 will charge up the capacitor 704. The capacitor 704 will continue to build up voltage as long as the signal remains static. After a pre-determined length of time, the capacitor 704 will have built up enough voltage to trip the comparator 706, thus allowing the analog integrator circuit 700 to assert that an SOF packet has been detected.

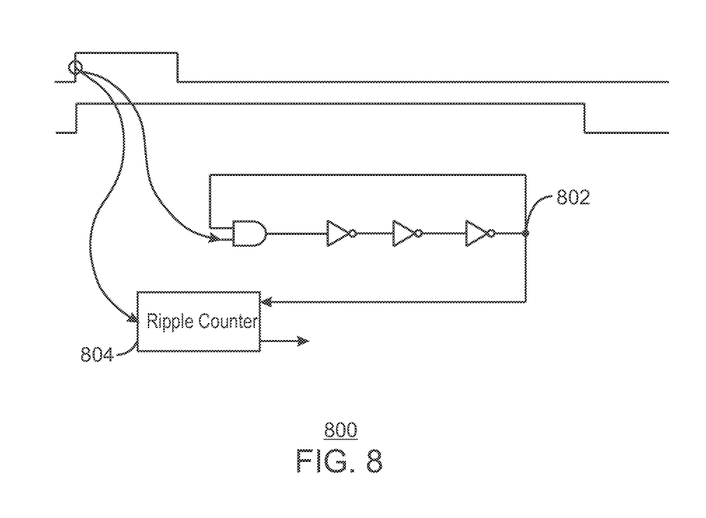

FIG. 8 is a digital counter circuit configured to determine whether or not a packet is a start-of-frame (SOF) packet. The digital counter circuit 800 can be used to determine whether or not a data packet includes the necessary number of consecutive static bits to be identified as an SOF packet. The digital counter circuit 800 can include a ring oscillator 802 and a ripple counter 804. When a signal of “1” or “0” is asserted, the ring oscillator 802 will start oscillating. The ripple counter 804 will include a readout that increases by one for each consecutive static bit that carries the same signal. If the signal changes, the ripple counter 804 will freeze the readout. If the readout is equal to or greater than a pre-determined number, then the digital counter circuit 800 can assert that an SOF packet has been detected.

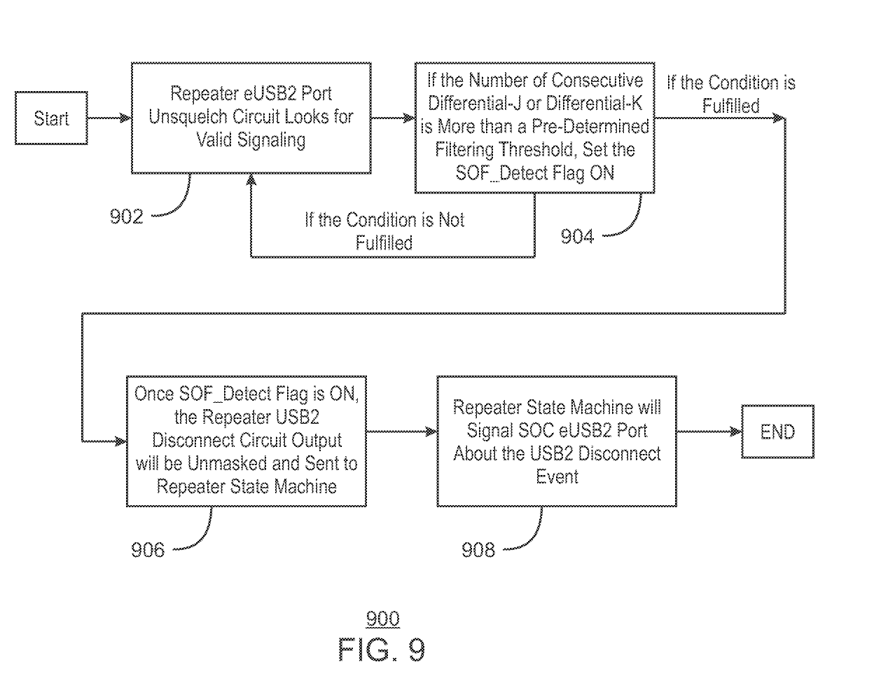

FIG. 9 is a process flow diagram of a method to detect device disconnect in a repeater in accordance with embodiments. The method 900 can be performed by a repeater that is communicatively coupled to a system-on-chip and a USB2 peripheral device. In some embodiments, the SOC utilizes eUSB2 communication protocol, and the USB2 peripheral device utilizes USB2 communication protocol.

At block 902, a repeater eUSB2 port unsquelch circuit looks for valid signaling. The valid signaling can be a data packet that includes a data payload segment and an end-of-packet (EOP) segment. The EOP segment can contain a number of consecutive static bits of differential-J (or “1”) or differential-K (or “0”). The number of consecutive static bits can identify whether or not the data packet is a start-of-frame (SOF) packet that is used to indicate device disconnect.

At block 904, the repeater determines whether to set an SOF_detect flag on. The repeater can inspect the data packet and check for the number of consecutive static bits contained in the EOP segment. If the number of consecutive differential-J or differential-K is more than a pre-determined filtering threshold, then the SOF_detect flag is set to ON. Setting the SOF_detect flag to ON indicates that an SOF packet has been detected.

At block 906, the repeater will have received an output from a repeater USB2 disconnect circuit (or disconnect envelope detector), indicating that a voltage swing that meets or exceeds a voltage threshold has been detected in the wires connecting the repeater's communication port to the USB2 peripheral device's communication port. If the SOF_detect flag is ON, the repeater USB2 disconnect circuit output will be unmasked and sent to the repeater state machine.

At block 908, the repeater communicates with the SOC eUSB2 port. The repeater state machine can signal the SOC eUSB2 port that a USB2 disconnect event has been detected.

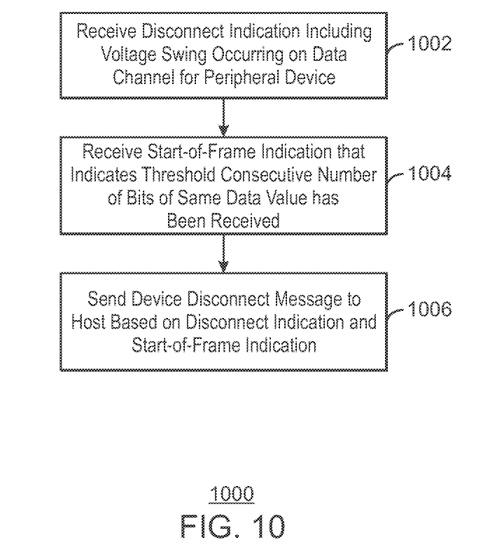

FIG. 10 is a process flow diagram of a summary of the method to detect device disconnect in a repeater. At block 1002, the repeater receives a disconnect indication comprising a voltage swing occurring on a data channel for a peripheral device. At block 1004, the repeater receives a start-of-frame indication that indicates that a threshold consecutive number of bits of the same data value has been received. At block 1006, the repeater sends a device disconnect message to a host based on the disconnect indication and the start-of-frame indication.

Although some embodiments have been described in reference to particular implementations, other implementations are possible according to some embodiments. Additionally, the arrangement and order of circuit elements or other features illustrated in the drawings or described herein need not be arranged in the particular way illustrated and described. Many other arrangements are possible according to some embodiments.

In each system shown in a figure, the elements in some cases may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method, comprising:
receiving a disconnect indication comprising a voltage swing occurring on a data channel for a peripheral device;
receiving a start-of-frame indication that indicates that a threshold consecutive number of bits of the same data value has been received; and
sending a device disconnect message to a host based on the disconnect indication and the start-of-frame indication.

2. The method of claim 1, wherein receiving the disconnect indication comprises determining that the voltage swing in a set of wires between a repeater port and a peripheral device port exceeds a voltage threshold.

3. The method of claim 1, wherein receiving the start-of-frame indication comprises receiving a packet comprising:
a data segment comprising no more than a predetermined number of consecutive static bits; and
an end-of-packet (EOP) segment comprising more than the predetermined number of consecutive static bits.

4. The method of claim 3, wherein the threshold consecutive number of bits of the same data value is larger than the predetermined number of consecutive static bits in the data segment, but not larger than the number of consecutive static bits in the EOP segment.

5. The method of claim 3, wherein the number of consecutive static bits in the EOP segment is 40.

6. The method of claim 1, further comprising:
measuring a differential voltage of the packet; and
converting the packet to single-ended signaling.

7. A repeater, comprising:
a first communication port, configured to transmit and receive data from a host port;
a second communication port, configured to transmit and receive data from a peripheral device port;
an unsquelch circuit, configured to receive a start-of-frame indication that indicates that a threshold consecutive number of bits of the same data value has been received from either of the first or secondsecond communications ports;
a disconnect envelope detector, configured to receive a disconnect indication comprising a voltage swing occurring on a data channel for a peripheral device and send an output indicating device disconnect; and
a repeater state machine, configured to send a device disconnect message to a host based on the disconnect indication and the start-of-frame indication.

8. The repeater of claim 7, wherein the start-of-frame indication is a packet comprising:
a data segment comprising no more than a predetermined number of consecutive static bits; and
an end-of-packet (EOP) segment comprising more than the predetermined number of consecutive static bits.

9. The repeater of claim 8, wherein the threshold consecutive number of bits of the same data value is larger than the predetermined number of consecutive static bits in the data segment, but not larger than the number of consecutive static bits in the EOP segment.

10. The repeater of claim 8, the repeater state machine to send the device disconnect message if both the disconnect indication and the start-of-frame indication are received.

11. The repeater of claim 7, wherein the disconnect detector envelope determines that the voltage swing in a set of wires between the second communication port and the peripheral device port exceeds a voltage threshold.

12. The repeater of claim 7, further comprising an analog integrator circuit communicatively coupled to the unsquelch circuit, the analog integrator circuit configured to determine that the threshold consecutive number of bits of the same data value in a packet received by either of the first or second communication ports has been met.

13. The repeater of claim 7, further comprising a digital counter circuit communicatively coupled to the unsquelch circuit, configured to determine that the threshold consecutive number of bits of the same data value in a packet received by the either of the first or second communication ports has been met.

14. A system, comprising:
a host comprising a host port;
a peripheral device comprising a peripheral device port; and
a repeater to forward data between the host and the peripheral device, the repeater comprising:
a first communication port to transmit and receive data from a host port;
a second communication port to transmit and receive data from a peripheral device port;
an unsquelch circuit to receive a start-of-frame indication that indicates that a threshold consecutive number of bits of the same data value has been received from either of the first or second communication ports;
a disconnect envelope detector to receive a disconnect indication comprising a voltage swing occurring on a data channel for a peripheral device and send an output indicating device disconnect; and
a repeater state machine to send a device disconnect message to the host based on the disconnect indication and the start-of-frame indication.

15. The system of claim 14, wherein the start-of-frame indication is a packet comprising:
a data segment comprising no more than a predetermined number of consecutive static bits; and
an end-of-packet (EOP) segment comprising more than the predetermined number of consecutive static bits.

16. The system of claim 15, wherein the threshold consecutive number of bits of the same data value is larger than the predetermined number of consecutive static bits in the data segment, but not larger than the number of consecutive static bits in the EOP segment.

17. The system of claim 15, the repeater state machine to send the device disconnect message if both the disconnect indication and the start-of-frame indication are received.

18. The system of claim 14, wherein the disconnect detector envelope determines that the voltage swing in a set of wires between the second communications port and the peripheral device port exceeds a voltage threshold.

19. The system of claim 14, the repeater further comprising an analog integrator circuit communicatively coupled to the unsquelch circuit, the analog integrator circuit configured to determine that the threshold consecutive number of bits of the same data value in a packet received by either of the first or second communication ports has been met.

20. The system of claim 14, the repeater further comprising a digital counter circuit communicatively coupled to the unsquelch circuit, configured to determine that the threshold consecutive number of bits of the same data value in a packet received by the either of the first or second communication ports has been met.
